(19) United States
(12) Patent Application Publication
(10) Pub. No.: US 2007/0199545 A1
(43) Pub. Date: Aug. 30, 2007

(54) Fuel system having variable waveform based on operator objective

(76) Inventor: Brian G. McGee, Chillicothe, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/647,139

(22) Filed: Dec. 29, 2006

(30) Foreign Application Priority Data
Dec. 31, 2005 (CN) 200510138165.6

(51) Int. Cl. F02M 57/02

(52) U.S. Cl. 123/480; 123/446

(57) ABSTRACT

A fuel control system for an engine having at least one combustion chamber is disclosed. The fuel control system has a source of pressurized fluid, a fuel injecting device, and a controller in communication with the fuel injecting device. The fuel injecting device receives the pressurized fluid and injects fuel into the combustion chamber of the engine in response to a fuel injection command signal. The controller receives an input indicative of an operator desired objective and selects a set of data corresponding to the operator desired objective from a plurality of sets of data stored within a memory of the controller. The controller then determines the fuel injection command signal from the selected set of data and at least one current operating condition of the engine.

### TECHNICAL FIELD

This invention relates generally to a fuel injection system and, more particularly, to a method and system for providing variable waveform commands to electronically controlled fuel injection devices based on an operator desired objective.

### BACKGROUND

Engine exhaust emission regulations are becoming increasingly more restrictive including, for example, regulations on the emission of hydrocarbons, carbon monoxide, particulate matter, and nitrogen oxides (NOx). One method implemented by engine manufacturers to control exhaust emissions and comply with the regulation of such emission standards is to tightly control the injection of fuel into combustion chambers of the engine. For example, the number of fuel injection pulses during a single engine cycle, the quantity of fuel injected during each injection pulse, the timing of the individual injection pulse(s), and the delivery rate of fuel during each injection may be varied to change emission characteristics of an engine. The electronic command signal sent to a fuel injecting device that results in a particular combination of fuel injection pulses may be considered a waveform.

At different engine operating conditions, it may be necessary to implement different waveforms in order to comply with emission regulations. For example, a first waveform may be utilized at certain steady-state engine operating conditions, including low engine speed and low engine load, a second waveform at a second steady state condition requiring high speed and high engine load, and a third wave form during a transient condition. In the past, this change between waveforms has been automatically initiated in order to remain compliant with emission regulations during engine operation throughout a range of speeds and loads.

Although these previous waveform-altering strategies may facilitate emission regulation compliance under varying operational conditions of an engine, there may be situations in which operator desired objectives other than emission regulation compliance are more important. For example, when operating within particular geographic regions, noise abatement may be of more concern than exhaust emissions. Likewise, the engine could operate in situations where fuel economy, responsiveness, maximum torque output, or other similar operator objectives outweigh exhaust emission control. When operating in these situations, existing waveform-altering systems may do little to facilitate achievement of the alternative operator desired objectives.

Accordingly, the present invention is directed to overcoming one or more of the problems as set forth above.

### SUMMARY OF THE INVENTION

In one aspect, the present disclosure is directed to a fuel control system for an engine having a combustion chamber. The fuel control system includes a source of pressurized fluid, a fuel injecting device, and a controller in communication with the fuel injecting device. The fuel injecting device is configured to receive the pressurized fluid and inject fuel into the combustion chamber of the engine in response to a fuel injection command signal. The controller is configured to receive an input indicative of an operator desired objective and select a set of data corresponding to the operator desired objective from a plurality of sets of data stored within a memory of the controller. The controller is also configure to determine the fuel injection command signal from the selected set of data and at least one current operating condition of the engine.

In another aspect, the present disclosure is directed to a method of operating a fuel control system. The method includes pressurizing a fluid and directing the pressurized fluid to a fuel injecting device. The method also includes receiving an input indicative of an operator desired objective and selecting a set of data corresponding to the operator desired objective from a plurality of sets of data. The method also includes determining a fuel delivery characteristic from the selected set of data and at least one current operating condition of an engine, generating an injection command signal indicative of the fuel delivery characteristic, and sending the injection command signal to the fuel injecting device.

### BRIEF DESCRIPTION OF THE DRAWINGS

FIG. 1 is a schematic view illustration of an exemplary disclosed fuel control system;

FIG. 2A is diagrammatic illustration of an exemplary disclosed fuel injection command signal associated with the fuel control system of FIG. 1;

FIG. 2B is a diagrammatic illustration of an exemplary disclosed fuel injection event resulting from the fuel injection command signal of FIG. 2A;

FIG. 3 is a diagrammatic illustration of exemplary disclosed fuel injection command signals corresponding to different operator objectives associated with operation of the fuel control system of FIG. 1; and

FIG. 4 is a flowchart illustrating an exemplary disclosed method of operating the fuel control system of FIG. 1.

### DETAILED DESCRIPTION

As used throughout this disclosure, an injection event is defined as the injections of fuel that occur during a single cycle of an engine. For example, one cycle of a four stroke engine includes the movement of a piston through an intake stroke, a compression stroke, an expansion or power stroke, and an exhaust stroke. Therefore, the injection event in a four stroke engine includes those injections or fuel shots that occur during one movement cycle of the piston through the four strokes. The term fuel shot, as used in the art, may refer to the actual injection of fuel or to the injection command signal sent to a fuel injecting device indicative of a desired injection of fuel into the engine.

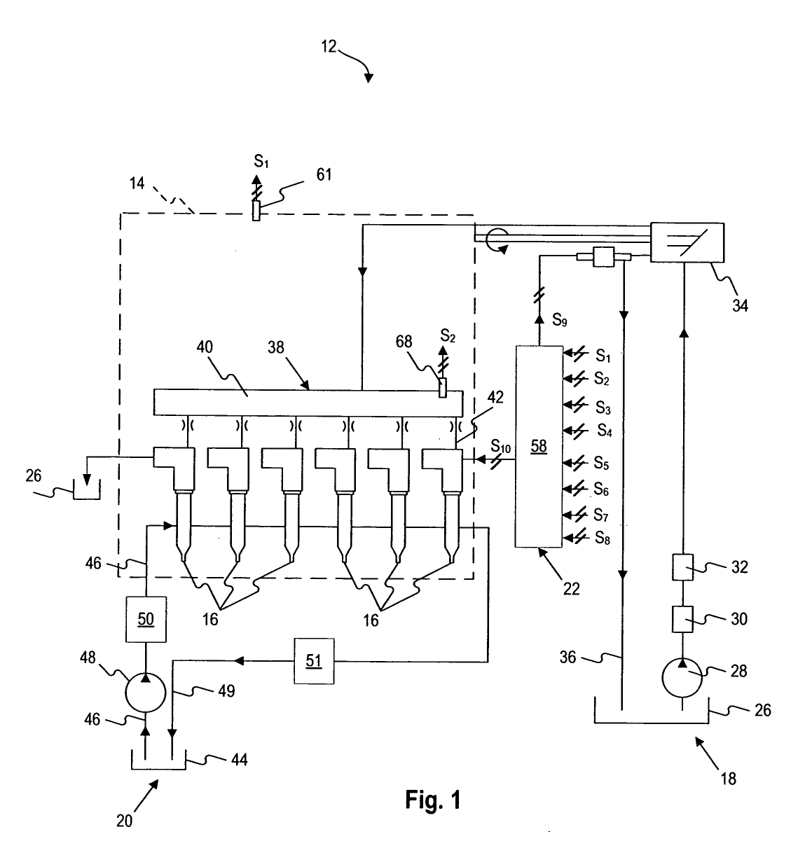

Referring to FIG. 1, there is shown an exemplary disclosed fuel injection system 12 configured for use with an internal combustion engine 14. Fuel injection system 12 may include one or more hydraulically actuated electronically controlled fuel injection devices, such as a fuel injector 16, which are positioned in respective cylinder head bores of engine 14. While the embodiment of FIG. 1 applies to an in-line six cylinder engine, it is to be understood that the presently disclosed fuel injection system 12 may also be equally applicable to other types of engines such as V-type and/or rotary engines, and that engine 14 may contain any number of cylinders or combustion chambers. In addition, while the embodiment of FIG. 1 illustrates fuel injectors 16 as being hydraulically actuated and electronically controlled, it is likewise recognized and anticipated that fuel injection system 12 may also equally include alternative types of fuel injection devices such as, for example, electronically actuated and controlled injectors, mechanically actuated electronically controlled injectors, digitally controlled fuel valves associated with a high pressure common fuel rail, or any other type of fuel injector known in the art.

Fuel injection system 12 may include a means 18 for supplying actuation fluid to each fuel injector 16, a means 20 for supplying fuel to each fuel injector 16, and a means 22 for electronically controlling the operation of fuel injectors 16 including the frequency and manner in which fuel is injected, start and stop timings of injections, number of injections per injection event, fuel quantity per injection, time delay between injections, and the pressure or flow profile of each injection.

The means 18 for supplying actuation fluid may preferably include an actuating fluid sump or reservoir 26, a relatively low pressure actuating fluid transfer pump 28, an actuating fluid cooler 30, one or more actuation fluid filters 32, a high pressure pump 34 for generating relatively high pressure in the actuation fluid, and at least one actuation fluid manifold 38. A common rail passage 40 within actuation fluid manifold 38 may be arranged in communication with the outlet of high pressure pump 34. A rail branch passage 42 may connect an actuation fluid inlet of each fuel injector 16 to common rail passage 40. In the case of a mechanically actuated electronically controlled injector, actuation fluid manifold 38, common rail passage 40, and rail branch passages 42 may be replaced with some type of cam actuating arrangement or other mechanical means for actuating such injectors. Examples of mechanically actuated electronically controlled fuel injector units are disclosed in U.S. Pat. Nos. 5,947,380 and 5,407,131.

In a preferred embodiment, the actuation fluid may be engine lubricating oil and the actuating fluid sump 26 may be an engine lubrication oil sump. In this manner, fuel injection system 12 may be connected as a parasitic subsystem to the engine's lubricating oil circulation system. Alternatively, the actuating fluid could be fuel.

The fuel supply means 20 may preferably include a fuel tank 44, a fuel supply passage 46 arranged in fluid communication between the fuel tank 44 and a fuel inlet of each fuel injector 16, a relatively low pressure fuel transfer pump 48, one or more fuel filters 50, a fuel supply regulating valve 51, and a fuel circulation and return passage 49 arranged in fluid communication between fuel tank 44 and each fuel injector 16.

Electronic control means 22 may preferably include a controller, specifically an electronic control module (ECM) 58, the general use of which is well known in the art. ECM 58 may include a microcontroller or microprocessor, a governor such as a proportional integral derivative (PID) controller for regulating engine speed, circuitry including input/output circuitry, power supply circuitry, signal conditioning circuitry, solenoid driver circuitry, analog circuits and/or programmed logic arrays, and an associated memory. The memory may be connected to the microcontroller or microprocessor to store instruction sets, maps, lookup tables, variables, relationships, equations, and more.

ECM 58 may control many aspects of fuel injection. These aspects may include (1) the fuel injection timing, (2) the total quantity of fuel injected during an injection event, (3) the fuel injection pressure, (4) the number of separate injections or fuel shots during each injection event, (5) the time interval(s) between the separate injections or fuel shots, (6) the time duration of each injection or fuel shot, (7) the actuation fluid pressure, (8) current level of an injector waveform, and (9) any combination of the above parameters. Each of these parameters may be variably controllable independent of engine speed and load.

ECM 58 may receive a plurality of sensor input signals S₁-S₈ which correspond to known sensor inputs associated with operating conditions of engine 14. For example, these sensor inputs may include engine speed, oil or coolant temperature, pressure of the actuation fluid and/or fuel, cylinder piston position, and other known conditions. In one embodiment, an engine temperature sensor 61 is illustrated in FIG. 1 as being connected to engine 14. Engine temperature sensor 61 may sense an engine oil temperature. However, an engine coolant temperature sensor could alternatively or additionally be used to detect the temperature of engine 14. Engine temperature sensor 61 may produce a signal designated as S₁, which may be directed to ECM 58. Similarly, a rail pressure sensor 68 is illustrated as being connected to actuation fluid manifold 38. Rail pressure sensor 68 may sense a rail pressure (e.g., the pressure of the actuation fluid within rail passage 40), and generate a signal designated as S₂, which may be directed to ECM 58.

These sensor inputs may be used to determine and control the precise combination of injection parameters for an injection event. In response to receiving one or more of signals S₁-S₈, ECM 58 may issue a control signal S₉ to control the pressure of actuation fluid from high pressure pump 34, and a fuel injection signal S₁₀ that causes each fuel injector 16 to inject fuel into each corresponding engine cylinder. Signal S₁₀ may include an ECM commanded current directed to a solenoid or other electrical actuator of fuel injectors 16.

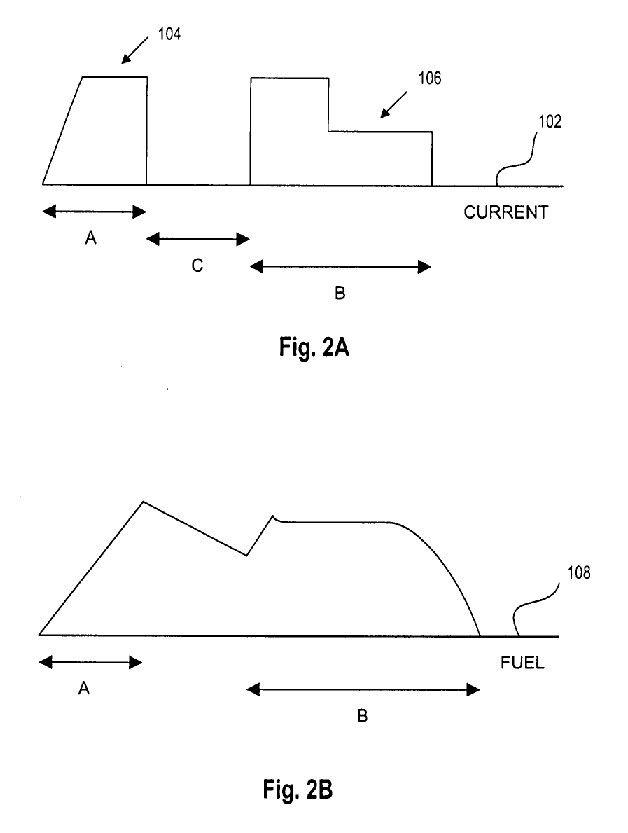

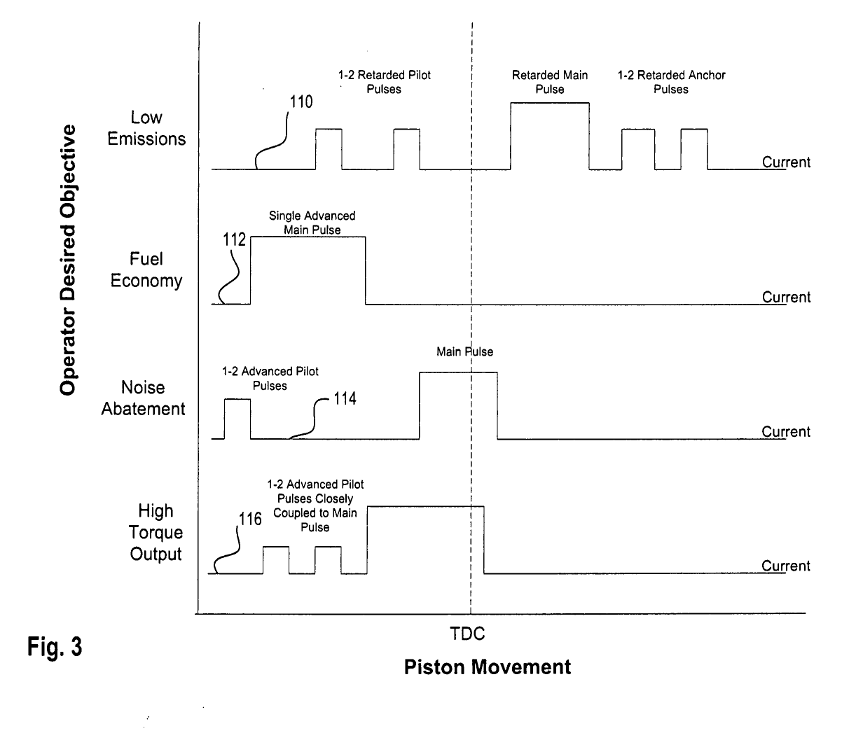

FIG. 2A illustrates an exemplary injection command signal S₁₀ also know as a “current waveform,” while FIG. 2B illustrates a corresponding fuel injection event. When injection command signal S₁₀ is sent to a fuel injector 16, the fuel injector 16 may respond by opening and closing a fuel valve element (not shown) according to characteristics of signal S₁₀. For example, a current waveform 102 contained with signal S₁₀ may include a command for injecting a main fuel shot 104 and an anchor fuel shot 106. This current waveform 102 may be a distinct split injection command having a unique anchor delay associated therewith and illustrated in FIG. 3A as region C between the commanded main fuel shot 104 and the commanded anchor fuel shot 106. Region A may correspond to the duration of the commanded main fuel shot 104, while region B may correspond to the duration of the commanded anchor fuel shot 106. Referring to FIG. 3B, a resulting exemplary valve opening or fuel delivery trace 108 is illustrated that may correspond to the current waveform 102 of FIG. 3A. Because fuel injector 16 does not react instantaneously to an applied current, the fuel valve element of fuel injector 16 may remain open after the current has been removed and, if the anchor delay C is sufficiently short, the start of the next current signal or applied current pulse may be received before the fuel valve element of fuel injector 16 can fully close. When the anchor delay C is sufficiently short, and when the main duration (e.g., region A) is of sufficiently short duration, a condition known as a “boot” may be produced.

It may be possible for ECM 58 to vary characteristics of the current waveform contained within the command signal S₁₀ in response to operator input. In particular, in response to a manual input, ECM 58 may vary the start time of each current pulse or “start of logic” (SOL), the end time of each current pulse or “end of logic” (EOL), the amplitude of each current pulse, shape of the current pulse, and the number of current pulses within the waveform of each command signal S₁₀ sent to fuel injectors 16. In addition, the actuation fluid pressure and/or the pressure of the fuel supplied to fuel injectors 16 may be regulated by ECM 58 during an injection event in response to the operator input.

The operator input may be received in any number of ways. For example, a manual input device such as a switch, a lever, a button, or other appropriate manual input device may be situated within an operator station. The manual input device may be movable between any number of predetermined positions to generate corresponding signals. Alternatively, the operator input may be received as a software configuration selected by the operator at startup or service of engine 14.

The operator input may correspond with a desired objective. That is, in response to moving the manual input device or selecting a specific software configuration, a corresponding signal may be sent to ECM 58 indicative of a desired objective. The objectives may include, for example, a low exhaust emission objective, a fuel economy objective, a noise abatement objective, a high torque output objective, and other objectives known in the art. These objectives may be predetermined and set during manufacture or service of engine 14.

As illustrated in FIG. 3, the selection of a predetermined objective may affect the command waveform sent within signal S₁₀. In particular, as illustrated by a first waveform 110, when operating under a low emission objective, an exemplary waveform may include 1-2 retarded pilot pulses, a retarded main pulse, and 1-2 retarded anchor pulses. As illustrated in a second waveform 112, when operating under a fuel economy objective, an exemplary waveform may include a single advanced main pulse. As illustrated in a third waveform 114, when operating under a noise abatement objective, an exemplary waveform may include 1-2 advanced pilot pulses, and a main pulse. As illustrated in a fourth waveform 116, when operating under a high torque objective, an exemplary waveform may include 1-2 advanced pilot pulses and an advanced main pulse, wherein all of the injection pulses are close coupled, possibly resulting in a boot condition.

Each operator objective may correspond with a particular set of data stored within the memory of ECM 58 and used to generate the waveforms exemplified by FIG. 3. In particular, ECM 58 may determine the corresponding waveform command by comparing various operational conditions of engine 14 with different relationship maps stored within the memory of ECM 58. For example, ECM 58 may compare conditions such as engine operating speed, desired speed, load, desired load, temperature, throttle setting, timing, fuel pressure, current gear ratio, travel speed, and other such conditions with various maps, tables, graphs, equations, and other forms of data stored within the memory of ECM 58 to determine injection characteristics corresponding with the desired objective. One example of a relationship map stored within ECM 58 may include a five-dimensional map relating rail pressure, total main and anchor fuel quantity, main pulse duration, anchor delay, and anchor pulse duration. Other maps may include, for example an injection timing map, a smoke limit map, a torque limit map, an altitude timing or fuel limiting map, and any other suitable map. Each operator objective may correspond with a particular set of these maps and be used in response to receiving the manually-generated signal to determine the fuel injection characteristics (e.g., the waveform command included within signal S₁₀).

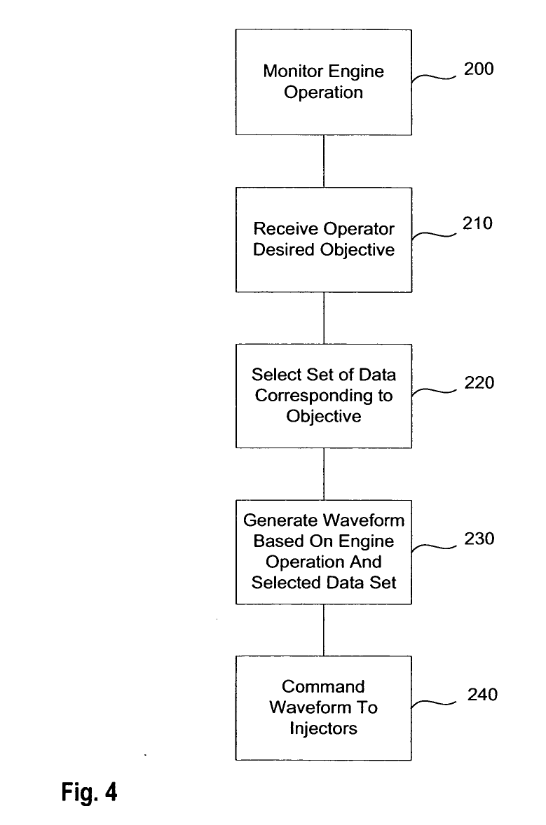

FIG. 4 illustrates a flow chart depicting an exemplary method of operating fuel control system 12. FIG. 4 will be discussed in the following section to further illustrate the disclosed injection system and its operation.

### INDUSTRIAL APPLICABILITY

Utilization of fuel injection system 12 may facilitate efficient achievement of a variety of operator desired objectives by varying the waveform commanded to a fuel injecting device. In particular, the present system may be capable of determining the fuel injection timing, the total quantity of fuel injected during an injection event, the fuel injection pressure, the number of separate injections or fuel shots during each injection event, the time interval(s) between the separate injections or fuel shots, the time duration of each injection or fuel shot, the actuation fluid pressure, and the current level of an injector waveform signal based on an operator desired objective and regardless of the type of electronically controlled fuel injectors, the type of engine, and the type of fuel utilized. In this regard, appropriate sets of data corresponding to a number of predetermined objectives can be stored or otherwise programmed into the ECM 58 for use during any condition of engine 14. These operational maps, tables and/or mathematical equations stored in the programmable memory of the ECM 58 may be referenced to determine and control the various parameters associated with the appropriate an injection event that achieves the operator desired objective. The operation of fuel injection system 12 will now be described.

As illustrated in FIG. 4, the first step toward injecting fuel into the combustion chamber of engine 14 may include monitoring the current operation of engine 14 (Step 200). Monitoring may include sensing a current engine temperature, a current fuel rail pressure, an engine speed, an engine load, a throttle position, or other similar operating condition. The parameters may then be stored within the memory of ECM 58 for later reference.

At startup of engine 14 or, alternatively, at any point during the operation of engine 14, ECM 58 may receive a signal indicative of an operator desired objective (Step 210). As noted above, the objective may correspond with one of a plurality of predetermined objectives and may be indicated via a manual input device or a manually selectable software configuration. Different examples of operator desired objectives may include a low emission objective, a fuel economy objective, a noise abatement objective, a high torque objective, or any other suitable objective. It is contemplated that step 210 may be performed at any time before, during, or after step 200, as desired.

After ECM 58 receives the input indicative of the operator desired objective, ECM 58 may select a set of corresponding data from a plurality of sets stored within the memory of ECM 58 (Step 220). As described above, the selected set of data may include one or more maps, tables, graphs, equations, or other forms of data specifically associated with accomplishing the particular objective manually selected by the operator. Once the set of data has been selected, the data, along with the monitored operation of engine 14, may be utilized by ECM 58 to generate a waveform command (Step 230). The step of generating the waveform command may include, among other things, determining a number of injection pulses, the timing of each injection pulse, the total quantity of fuel injected as a result of the injection pulses, the time interval(s) between the separate pulses, and the time duration of each pulse. Once the waveform command has been generated, it may be sent to fuel injectors 16 in the form of signal S₁₀ (Step 240).

As is evident from the foregoing description, certain aspects of fuel injection system 12 are not limited by the particular details of the examples illustrated herein and it is therefore contemplated that other modifications and applications, or equivalencies thereof, will occur to those skilled in the art. It is accordingly intended that the claims shall cover all such modifications and applications that do not depart from the spirit and scope of the present disclosure.

Other aspects, objects and advantages of the present invention can be obtained from a study of the drawings, the disclosure and the appended claims.

What is claimed is:

1. A fuel control system for an engine having a combustion chamber, the fuel control system comprising:
a source of pressurized fluid;
a fuel injecting device configured to receive the pressurized fluid and inject fuel into the combustion chamber of the engine in response to a fuel injection command signal; and
a controller in communication with the fuel injecting device, the controller being configured to:
receive an input indicative of an operator desired objective;
select a set of data corresponding to the operator desired objective from a plurality of sets of data stored within a memory of the controller; and
determine the fuel injection command signal from the selected set of data and at least one current operating condition of the engine.

2. The fuel control system of claim 1, wherein the input includes a manually selectable software configuration.

3. The fuel control system of claim 1, wherein the input is received via an input device manually movable between a plurality of positions, each of the plurality of positions corresponding to a predetermined operator desired objective.

4. The fuel control system of claim 1, wherein each of the plurality of sets of data corresponds with a different predetermined operator desired objective.

5. The fuel control system of claim 4, wherein:
one of the plurality of sets of data corresponds with a low exhaust emission objective;
one of the plurality of sets of data corresponds with a noise abatement objective; and
one of the plurality of sets of data corresponds with a fuel economy objective.

6. The fuel control system of claim 1, wherein the controller is configured to determine the fuel delivery signal by determining a number of injection pulses during a single injection event.

7. The fuel control system of claim 6, wherein the controller is configured to determine the fuel delivery signal by also determining the duration of each fuel injection pulse during a multi-pulse injection event, and a delay between each of the injection pulses.

8. The fuel control system of claim 1, wherein each set of data includes at least one of a fuel timing map, a torque limit map, and a smoke limit map.

9. The fuel control system of claim 8, wherein each set of data also includes a relationship map relating at least a pressure of fluid delivered to the fuel injecting device, a total fuel quantity delivered during a single injection event, and a main injection pulse duration.

10. A method of operating a fuel control system, comprising:
pressurizing a fluid and directing the pressurized fluid to a fuel injecting device;
receiving an input indicative of an operator desired objective;
selecting a set of data corresponding to the operator desired objective from a plurality of sets of data;
determining a fuel delivery characteristic from the selected set of data and at least one current operating condition of an engine;
generating an injection command signal indicative of the fuel delivery characteristic; and
sending the injection command signal to the fuel injecting device.
